(19) United States
(12) Patent Application Publication
(10) Pub. No.: US 2016/0219383 A1
(43) Pub. Date: Jul. 28, 2016

(54) CABLE FOR POWER AND DATA TRANSMISSION IN AUDITORY PROSTHESES

(71) Applicants: Oliver John Ridler, Macquarie University (AU); James Vandyke, Macquarie University (AU)

(72) Inventors: Oliver John Ridler, Macquarie University (AU); James Vandyke, Macquarie University (AU)

(21) Appl. No.: 15/003,106

(22) Filed: Jan. 21, 2016

Related U.S. Application Data
(60) Provisional application No. 62/106,270, filed on Jan. 22, 2015.

(51) Int. Cl. H04R 25/00; H04R 1/10

(52) U.S. Cl. CPC H04R 25/556; H04R 1/1033; H04R 25/606; H04R 2420/09; H04R 2225/021; H04R 2225/31; H04R 2225/67

(57) ABSTRACT

Cables are utilized to both charge components of an auditory prosthesis and transmit data signals between components of the auditory prosthesis. The cable is configured so as to enable a recipient to charge her device without having to lose the hearing function of the auditory prosthesis. Connectors can be utilized to connect to the various components of the auditory prosthesis, as well as to a discrete power source. The cable can be connected directly to each component of the auditory prosthesis or can be connected via cables that are already a part of the auditory prosthesis.

### BACKGROUND

Hearing loss, which can be due to many different causes, is generally of two types: conductive and sensorineural. Sensorineural hearing loss is due to the absence or destruction of the hair cells in the cochlea that transduce sound signals into nerve impulses. Various hearing prostheses are commercially available to provide individuals suffering from sensorineural hearing loss with the ability to perceive sound. For example, cochlear implants use an electrode array implanted in the cochlea of a recipient (i.e., the inner ear of the recipient) to bypass the mechanisms of the middle and outer ear. More specifically, an electrical stimulus is provided via the electrode array to the auditory nerve, thereby causing a hearing percept.

Conductive hearing loss occurs when the normal mechanical pathways that provide sound to hair cells in the cochlea are impeded, for example, by damage to the ossicular chain or the ear canal. Individuals suffering from conductive hearing loss can retain some form of residual hearing because some or all of the hair cells in the cochlea functional normally.

Individuals suffering from conductive hearing loss often receive a conventional hearing aid. Such hearing aids rely on principles of air conduction to transmit acoustic signals to the cochlea. In particular, a hearing aid typically uses an arrangement positioned in the recipient's ear canal or on the outer ear to amplify a sound received by the outer ear of the recipient. This amplified sound reaches the cochlea causing motion of the perilymph and stimulation of the auditory nerve.

In contrast to conventional hearing aids, which rely primarily on the principles of air conduction, certain types of hearing prostheses commonly referred to as bone conduction devices, convert a received sound into vibrations. The vibrations are transferred through the skull to the cochlea causing motion of the perilymph and stimulation of the auditory nerve, which results in the perception of the received sound. Bone conduction devices are suitable to treat a variety of types of hearing loss and can be suitable for individuals who cannot derive sufficient benefit from conventional hearing aids.

### SUMMARY

Disclosed are embodiments of cables that allow for both charging of auditory prosthesis and transmission of data signals that utilize connectors for multiple components of the auditory prosthesis, along with a power connector. The cable is configured so as to enable a recipient to charge her auditory prosthesis without having to lose the hearing function thereof. The cable can be connected directly to each component of the auditory prosthesis or can be connected via cables that are already a part of the auditory prosthesis.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1A is a view of a percutaneous bone conduction device worn on a recipient.

FIG. 1B is a schematic diagram of a percutaneous bone conduction device.

FIG. 2A is a perspective view of an embodiment of an auditory prosthesis, including an implantable portion, an external portion, and a behind the ear portion.

FIG. 2B is a schematic view of an external portion and a behind-the-ear portion of an auditory prosthesis connected with a power and data signal transmission cable in accordance with one embodiment of the present technology.

FIGS. 3A-3B are schematic views of power and data signal transmission cables in accordance with embodiments of the present technology.

FIG. 4 is a schematic view of a power and data signal transmission cable in accordance with another embodiment of the present technology.

FIGS. 5A-5E are schematic views of external portions and behind-the-ear portions of auditory prostheses connected with power and data signal transmission cables in accordance with embodiments of the present technology.

FIG. 6 is a schematic view of a behind-the-ear portion of an auditory prosthesis connected to the power and data signal transmission cable of FIG. 4C.

FIGS. 7A-7B are partial perspective views of external portions of auditory prostheses, in accordance with embodiments of the present technology.

FIG. 8 is a method of transmitting power and data signals between components of an auditory prosthesis.

### DETAILED DESCRIPTION

While the aspects disclosed herein have particular application in cochlear implant devices and percutaneous bone conduction devices described herein, it will be appreciated that the systems, methods, and apparatuses disclosed can be employed to provide power to other types of hearing prostheses. For example, the embodiments disclosed herein can be used to power or charge hearing prostheses, active transcutaneous bone conduction devices, passive transcutaneous devices, middle ear devices, or other devices that include a battery. These batteries can be removable or hardwired. Furthermore, the embodiments disclosed herein can be utilized to power or charge medical devices other than hearing prostheses. The technologies disclosed herein will be described generally in the context of wearable portions or components of medical devices where at least one of the wearable portions contains a battery. For clarity, however, external portions and a behind-the-ear (BTE) portions of bone conduction devices and cochlear implants are generally described. Power provided to the devices by an on-board battery or power source is generally described herein as internal power. Power provided to the devices by a discrete power source is referred to herein as external power.

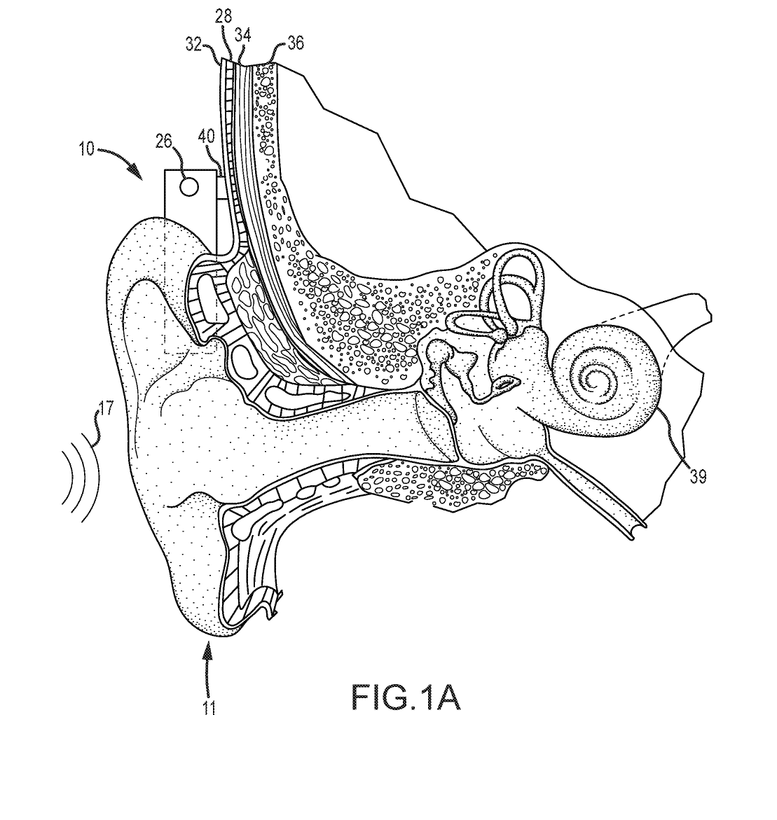

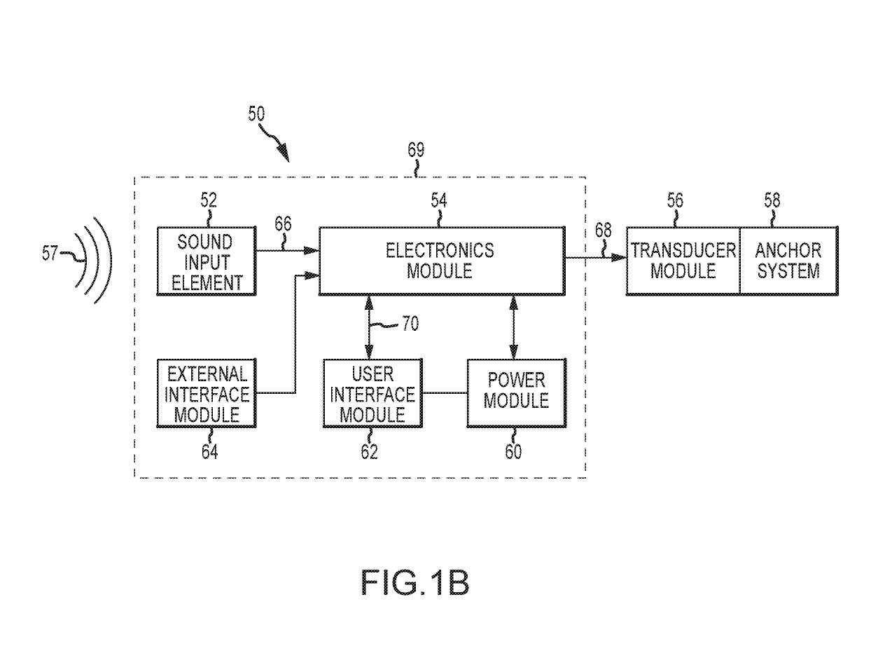

FIG. 1A is a perspective view of a percutaneous bone conduction device having an external portion 10 positioned behind outer ear 11 of the recipient. The illustrated external portion 10 houses a vibrating electromagnetic actuator that transmits vibrational stimulation to the skull bone 36 of the recipient. A discrete BTE portion (not shown in FIG. 1A) drives the electromagnetic actuator. A control signal is typically transferred from the BTE portion to the external portion 10 via a wired connection. The illustrated external portion 10 includes a cable connector port 26 that is compatible with the connector of a complimentary cable (not shown).

The BTE portion houses a sound input element and sound processor. The sound input element can be a microphone, telecoil or similar. In embodiments, the sound input device converts received sound signals into electrical signals. These electrical signals are processed by the sound processor. The sound processor generates control signals that cause the actuator to vibrate. In other words, the actuator utilizes a mechanical force to impart vibrations to skull bone 36 of the recipient.

External portion 10 further includes coupling apparatus 40 to attach external portion 10 to the recipient. In the example of FIG. 1A, coupling apparatus 40 is attached to an anchor system (not shown) implanted in the recipient. An exemplary anchor system (also referred to as a fixation system) can include a percutaneous abutment such as a bone screw fixed to the recipient's skull bone 36. The abutment extends from skull bone 36 through muscle 34, fat 28, and skin 32 so that coupling apparatus 40 can be attached thereto. Such a percutaneous abutment provides an attachment location for coupling apparatus 40 that facilitates efficient transmission of mechanical force. Another exemplary anchor system can include a magnetic transcutaneous fixture with a magnet fixed the recipient's skull bone 36 in place of a percutaneous abutment.

A functional block diagram of one example of a bone conduction device 50 is shown in FIG. 1B. Sound 57 is received by sound input element 52 housed within the BTE 69. In some arrangements, sound input element 52 is a microphone configured to receive sound 57, and to convert sound 57 into electrical signal 66. Alternatively, sound 57 is received by sound input element 52 as an electrical signal.

As shown in FIG. 1B, electrical signal 66 is output by sound input element 52 to electronics module 54. Electronics module 54 is configured to convert electrical signal 66 into adjusted electrical signal 68. As described below in more detail, in certain embodiments, electronics module 54 can include a sound processor, control electronics, transducer drive components, and a variety of other elements housed within the BTE 69. Additionally, electronics module 54 can also include signal detectors that detect signal sent from other components of the bone conduction device 50.

As shown in FIG. 1B, actuator or transducer 56 receives adjusted electrical signal 68 from the BTE 69 and generates a mechanical output force in the form of vibrations that are delivered to the skull of the recipient via anchor system 58, which is coupled to bone conduction device 50. Delivery of this output force causes motion or vibration of the recipient's skull, thereby activating the hair cells in the recipient's cochlea 39 (depicted in FIG. 1A) via cochlea fluid motion.

FIG. 1B also illustrates power module 60. Power module 60 provides electrical power to one or more components of bone conduction device 50. For ease of illustration, power module 60 has been shown connected only to user interface module 62 and electronics module 54. However, it should be appreciated that power module 60 can be used to supply power to any electrically powered circuits/components of bone conduction device 50.

User interface module 62, which is included in the BTE 69, allows the recipient to interact with bone conduction device 50. For example, user interface module 62 can allow the recipient to adjust the volume, alter the speech processing strategies, power on/off the device, initiate an actuator balance test, etc. In certain embodiments, the user interface module 62 can include one or more buttons disposed on an outer surface of the BTE housing 69. In the example of FIG. 1B, user interface module 62 communicates with electronics module 54 via signal line 70.

Bone conduction device 50 can further include an external interface module 64 that can be used to connect electronics module 54 to an external device, such as a fitting system. Using the external interface module 64, the external device can obtain information from the bone conduction device 50 (e.g., the current parameters, data, alarms, etc.) and/or modify the parameters of the bone conduction device 50 used in processing received sounds and/or performing other functions. In embodiments, the external interface module 64 can also be utilized to connect the bone conduction device 50 to an external device such as a home or audiologist computer, or to a smartphone via a wireless (e.g., Bluetooth) connection, so as to perform the actuator balance tests described herein.

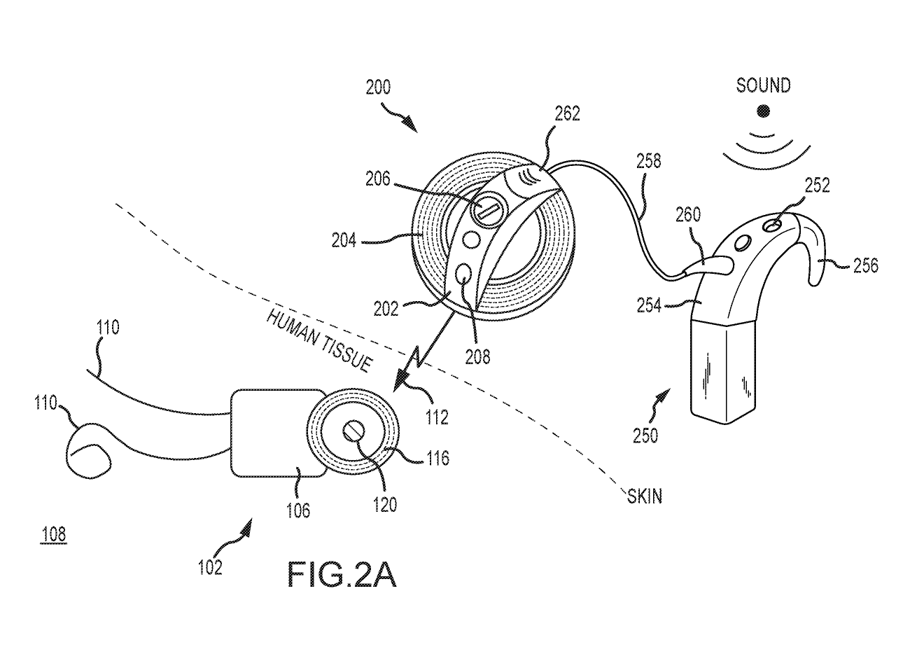

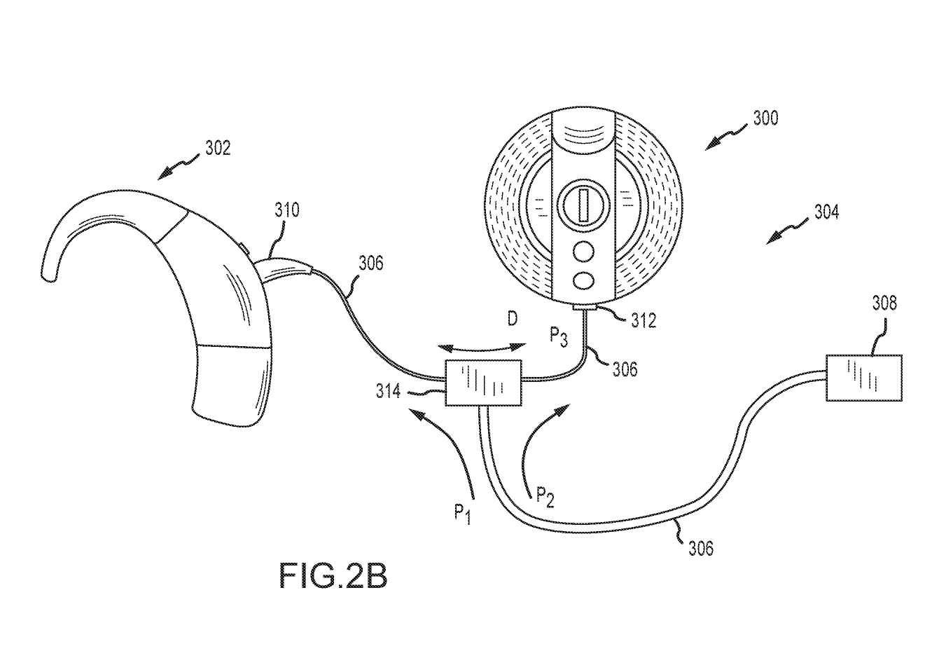

FIG. 2A is a perspective view of an embodiment of an auditory prosthesis 100, in this case, a cochlear implant, including an implantable portion or component 102, an external portion or component 200, and a BTE portion 250 connected to the external portion 200. The implantable portion 102 of the cochlear implant includes a stimulating assembly 106 implanted in a body (specifically, proximate and within the cochlea 108) to deliver electrical stimulation signals to the auditory nerve cells, thereby bypassing absent or defective hair cells. The electrodes 110 of the stimulating assembly 106 activate auditory neurons that normally encode differential pitches of sound. This stimulating assembly 106 enables the brain to perceive a hearing sensation resembling the natural hearing sensation normally delivered to the auditory nerve.

Typically, a sound processor is disposed in the BTE portion 250 and a signal associated therewith is sent from the BTE portion 250, to the external portion 200, then to the implantable portion 102, via a coded signal 112. The coded signal 112 is sent to the implanted stimulating assembly 106 via a transcutaneous link. In one embodiment, the signal 112 is sent from a transmission element such as an induction coil 204 located on the external portion 200 to a coil 116 on the implantable portion 102. In other embodiments, the transmission element can be a vibration element. The stimulating assembly 106 processes the coded signal 112 to generate a series of stimulation sequences which are then applied directly to the auditory nerve via the electrodes 110 positioned within the cochlea 108. The external portion 200 can also include a battery (contained within a housing 202) and a status indicator 208. Permanent magnets 120, 206 are located on the implantable portion 102 and the external portion 104, respectively.

The BTE portion 250 includes a housing 254 and an ear hook 256 that helps locate the BTE portion 250 on a recipient's ear. A microphone inlet 252 defined by the housing allows sound to be received by a microphone, which is then processed by a sound processor contained therein. Additionally, the BTE portion 250 can include an internal battery (not shown) that powers the various components of the BTE portion 250, as well as components of the external portion 200. In other embodiments, the external portion 200 can also include an internal battery and charging circuit (not shown). A connector 260 connects one end of the cable 258 to the BTE portion 250 and a connector 262 connects the opposite end of the cable 260 to the external portion 200, for transmission of power, data (sound), and other signals. The cable connectors 260, 262, in certain embodiments, are male connectors that project into female connectors on the BTE portion 250 and external portion 200. In other embodiments, female-to-male connectors can be used. As used herein, the term “connector” refers to any types of plugs, contacts, or other connection elements that connect to devices and allow for electronic data communication, power transfer, etc., between those two components. Such connectors can include male and female portions of connectors in forms such as USB, mini USB, micro USB, plugs, mini plugs, micro plugs, and others.

In certain auditory prostheses, expired batteries must be removed and either replaced or recharged. In other auditory prostheses, the external portion thereof is placed on a charging mat or similar device to charge a battery disposed in the external portion or the BTE portion. The power signal received via the coil in the external portion is transferred via a cable to charge the battery in the BTE portion, which will later provide power to the external portion, as required during use. Regardless, removing batteries or placing an external coil on a charging mat reduces or eliminates a recipient's ability to hear. In contrast thereto, the technologies described herein enable a recipient to charge an on-board battery of her auditory prosthesis while maintaining the ability of the prosthesis to sends data signals to the external portion (and therefore the implantable portion) of the auditory prosthesis. Prostheses that utilize rechargeable batteries that must be removed for charging, or that are hardwired and are recharged on-board, can benefit from the technologies described herein. This allows for hearing during charging operations, thus allowing a recipient to charge the battery of her device “on the go.” A specialized cable allows transmission of data signals bi-directionally between the BTE portion and the external portion, while a power connector is utilized to deliver power to either or both of the BTE portion and the external portion to charge any batteries contained therein. The power connector can be a USB plug that can be connected to a multitude of devices (such as vehicle power adapters, building power supplies, energy scavengers, remote batteries, etc.) that provide, e.g., 5V power for charging. In another embodiment, the power connector can be a battery contact in a chamber configured to receive a battery. In another embodiment, the power connector can be a contact or wire that is hard-wired to a battery. In one embodiment, the cable delivers a voltage to the BTE portion to recharge the battery, and also provides a voltage to the coil of the external portion to enable the auditory prosthesis to still operate and provide stimulation or data signals (sound) to the recipient so as to produce a hearing percept. Thus, hearing functionality is maintained while charging the battery.

FIG. 2B is a schematic view of an external portion 300 and a BTE portion 302 of an auditory prosthesis connected with a power and data signal transmission cable 304. Embodiments of the external and BTE portions 300, 302 are described in more detail above. The cable 304 includes an outer jacket 306 that contains a number of wires (various wire configurations are described below). A number of connectors are secured to the cable jacket 306. A power connector 308 is disposed at one end of the cable 304 and is configured to be connected to a power source, as described above. A first connector 310 is configured to be connected to the BTE portion 302, while a second connector 312 is configured to be connected to the external portion 300. The terms “first” and “second” when describing connectors are used to distinguish one connector from the other connector, but in other embodiments, the described “first” connector 310 can be connected to the external portion 300 instead of the BTE portion 302. The cable 304 includes a junction 314 typically disposed between the BTE portion 302 and the external portion 300. In typical auditory prostheses, power signals are transmitted from BTE portion 302 to the external portion 300. The depicted cable 304 delivers power from the power source connected to the power connector 308 to both the BTE portion 302 and the external portion 300 as power signals P₁ and P₂. Data signal D is also transmitted bi-directionally between the BTE portion 302 and the external portion 300 during charging, thus ensuring the recipient can continue to hear during charging operations. In other embodiments, the cable 304 can be configured so as to deliver power signal P₁ to the BTE portion 302, without delivering power signal P₂ to the external portion 300. In such an embodiment, power signal P₃ is instead sent from BTE portion 302 to the external portion 300, along with data signal D. Other signals can be sent between the various connectors (and therefore various auditory prosthesis portions and the power source) as described below.

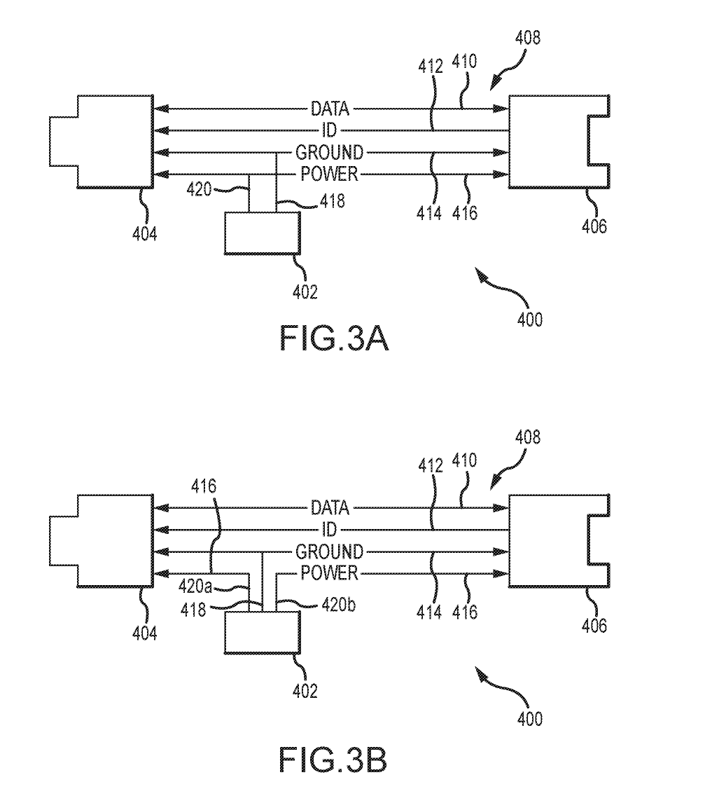

FIGS. 3A-3B are schematic views of power and data signal transmission cables 400 in accordance with embodiments of the present technology. Each of the cables includes a power connector 402, a first connector 404, and a second connector 406. In the depicted embodiment, the first connector 404 is a male plug adapted to be connected to a BTE portion of an auditory prosthesis, not shown, while the second connector 406 is a female plug adapted to be connected to an external portion of an auditory prosthesis, also not shown. Other connector configurations are contemplated. In FIG. 3A, the cable 400 includes a multi-wire bundle 408 disposed within a cable jacket (not shown). The wire bundle 408 includes wires for data 410, identification 412, ground 414, and power 416. Although a greater or fewer number of wires in the wire bundle 408 are contemplated, the depicted wires are operatively connected to the connectors, as shown, to allow for transmission of any number of the following signals. The data wire 410 allows for the transmission of stimulation signals or other data signals (e.g., diagnostic signals) between the first connector 404 and second connector 406. The identification wire 412 allows for the transmission of identification signals from the second connector 406 to the first connector 404. Such identification signals can enable the BTE portion to detect the presence, operational condition, etc., of the external portion. The ground wire 414 is a return path for the power signal, while the power wire 416 allows for the transmission of power. A single ground wire 418 and a single power wire 420 are connected to the power connector 402. Thus, during combined charging/hearing operations, data signals may be sent along the data wire 410 and identification signals sent along the identification wire 412. Both the BTE portion and external portion are grounded via the ground wire 414 and the single ground wire 418 connected to the power connector 402. Additionally, power is delivered to both the BTE portion and external portion via the power wire 414 and the single power wire 420 connected to the power connector 402. In such an embodiment, it is likely that the power signal used to charge a battery on board the BTE portion is of a higher voltage than that required to deliver operational power to the external portion. Thus, a voltage transformer can be disposed on the power wire 416, proximate either or both of the first connector 404 and the second connector 406. Indeed, in certain embodiments, such a voltage transformer can be incorporated into the first connector 404 or the second connector 406. In other embodiments, the voltage transformer can be incorporated into the power connector 402, the BTE portion itself, the external portion itself, or any device connected to the power connector 402.

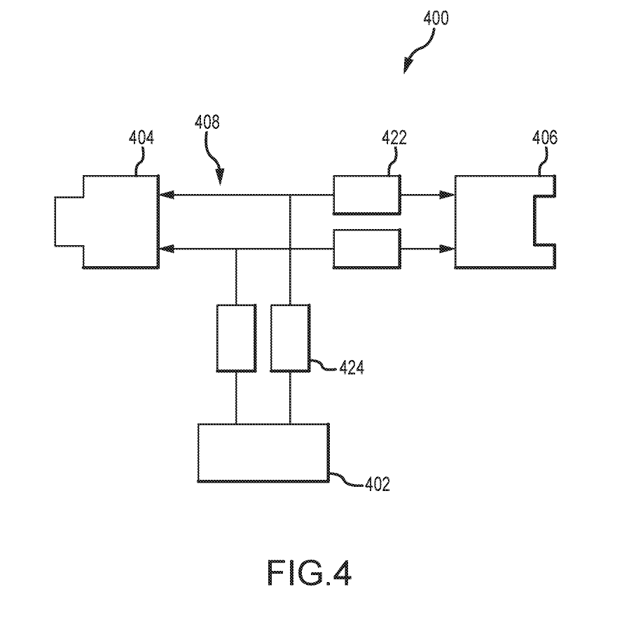

In FIG. 3B, the cable 400 includes a multi-wire bundle 408 disposed within a cable jacket (not shown). As with the embodiment of FIG. 3A, a power connector 402, first connector 404, and second connector 406 are utilized, along with a wire bundle 408 that includes wires for data 410, identification 412, ground 414, and power 416. A single ground wire 418 is connected to the power connector 402. In FIG. 4B, however, two power wires 420a, 420b are connected to the power connector 402 and connected directly to the first connector 404 and second connector 406, respectively. Thus, dedicated power signals can be sent to each of the BTE portion and the external portion. In such an embodiment, a voltage transformer can be disposed on the power wire 416 to the first connector 404 or the power wire 416 to the second connector 406. Alternatively, such a voltage transformer can be incorporated into the power connector 402, transforming the power delivered to either or both of power wire 420a or power wire 420b.

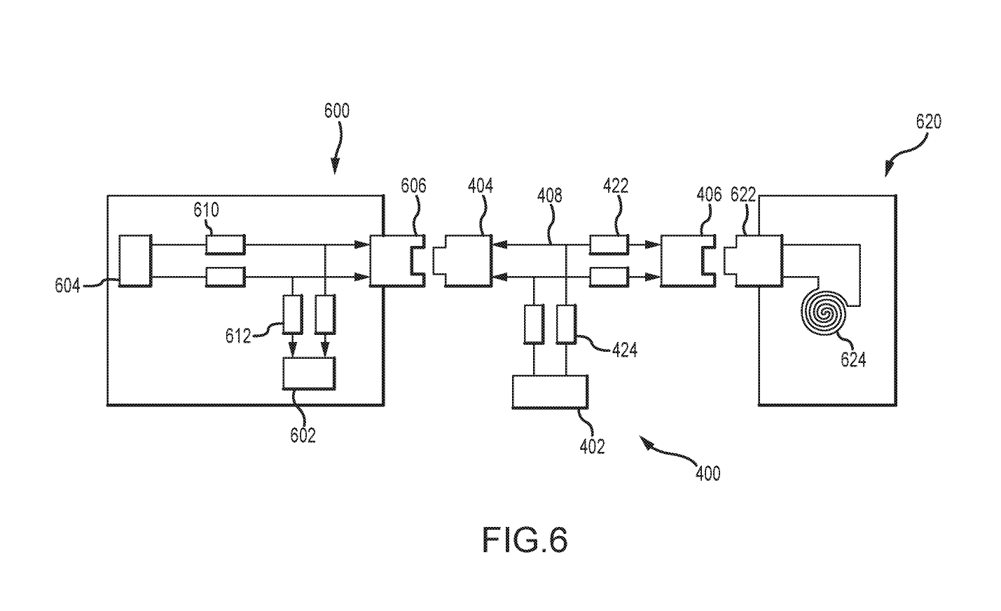

In FIG. 4, the cable 400 includes a multi-wire bundle 408 disposed within a cable jacket (not shown). As with the embodiment of FIG. 3A, a power connector 402, first connector 404, and second connector 406 are utilized, along with a wire bundle 408. The depicted wire bundle 408, however, includes two wires, which can be direct coil winding connections for a passive coil used in an external portion. Typically, in such a configuration, a high frequency sinusoid present on the two wires is delivered to the coil of the external portion. When the wires of the wire bundle 408 are used for the transmission of power from power connector 402, the DC power is separated from the data signal sent to the coil. The high pass filters 422 and low pass filters 424 separate the power signal from the data signal. The high pass filters 422 prevent transmission of DC power to the coil via the second connector 406. The low pass filters 424 prevent transmission of data back to the power connector 402. This cable 400 is described further in the context of a BTE portion used in conjunction with an external portion having a passive coil in FIG. 6, below.

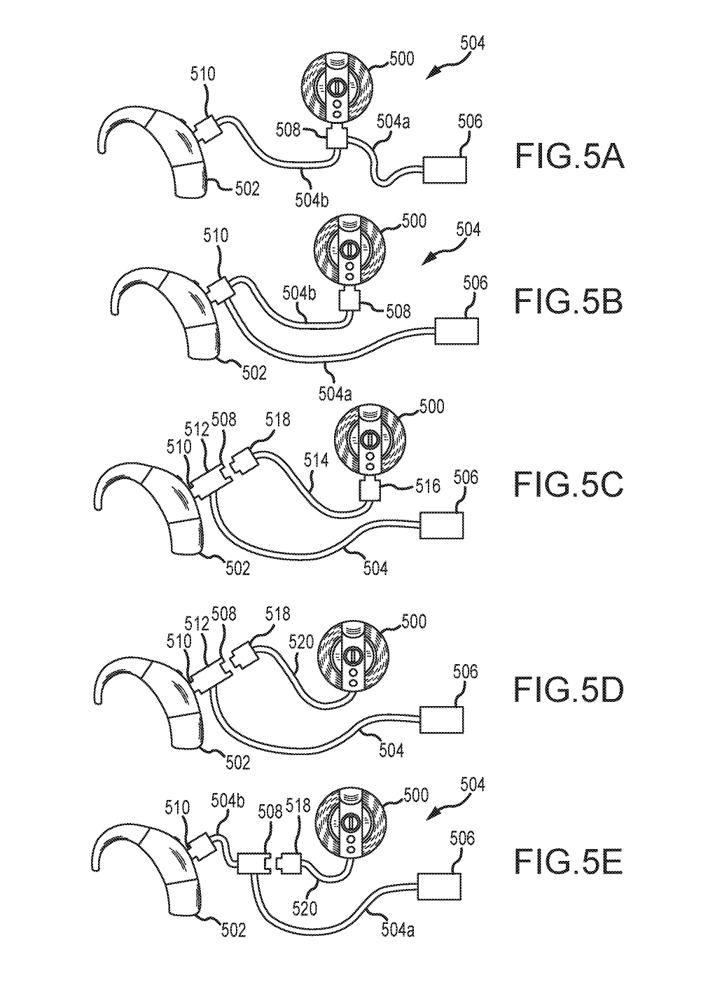

FIGS. 5A-5E are schematic views of external portions 500 and BTE portions 502 of auditory prostheses connected with power and data signal transmission cables 504 in accordance with embodiments of the present technology. Typically, and as described elsewhere herein, the external portion 500 and BTE portion 502 of an auditory prosthesis are connected via a two-connector cable, such as that depicted in the auditory prosthesis of FIG. 2. That is, the cable 258 includes two connectors 260, 262, one for each portion of the auditory prosthesis. The technologies described herein contemplate a number of different configurations for power and data transmission cables 504 in accordance with the teachings herein. Certain of these embodiments are depicted in FIG. 3, above, and FIGS. 5A-5E. Other embodiments are also contemplated. The cable 504 includes a power connector 506, a first connector 508, and a second connector 510. In the depicted embodiments, the first connector 508 is configured to transmit signals to and from the external portion 500, while the second connector 510 is configured to transmit signals to and from the BTE portion 502. The specific wiring connections to and between the various connectors 506, 508, 510 contained in the cable 504 can be made in accordance with the present disclosure.

FIG. 5A, a first portion 504a of the cable 504 is connected to both the power connector 506 and the first connector 508. A second portion 504b of the cable 504 is connected to both the first connector 508 and the second connector 510. FIG. 5B, a first portion 504a of the cable 504 is connected to both the power connector 506 and the second connector 510. A second portion 504b of the cable 504 is connected to both the first connector 508 and the second connector 510. FIG. 5C, the cable 504 is connected to both the power connector 506 and a combined connector 512 that integrates both the first connector 508 and the second connector 510. In such an embodiment, the second connector 510 can be a male connector while the first connector 508 can be a female connector. A removable cable 514 connects to the external portion 500 at an external portion connector 516, while a BTE connector 518 is connected to the first connector 508. In this embodiment, the removable cable 514 can be the cable that typically connects the external portion 500 to the BTE portion 502 during regular operation of the auditory prosthesis using the internal power supply. After charging, the cable 504 can be disconnected from the BTE portion 502 and the removable cable 514 re-connected thereto.

Similar to the embodiment of FIG. 5C, the cable 504 in FIG. 5D is connected to both the power connector 506 and combined connector 512 that integrates both the first connector 508 and the second connector 510. An integrated cable 520 is permanently secured to the external portion 500. A BTE connector 518, typically connected directly to the BTE portion 502 during hearing procedures, is connected to the first connector 508. After charging, the cable 504 can be disconnected from the BTE portion 502 and the integrated cable 520 re-connected thereto. FIG. 5E utilizes a first portion 504a of cable 504 that connects the power connector 506 to the first connector 508, and a second portion 504b of cable 504 that connects the first connector 508 and the second connector 510. The integrated cable 520 having a BTE connection 518 can be connected to the first connector 508 during charging operations. The BTE connection 518 can then be re-connected to the BTE portion 502 after charging. All of the depicted cable embodiments allow for charging of batteries of an auditory prosthesis without the loss of hearing functionality thereof.

FIG. 6 is a schematic view of a BTE portion 600 and an external portion 620 of an auditory prosthesis connected to the power and data signal transmission cable 400 of FIG. 4. The cable 400 is described above in FIG. 4. The BTE portion 600 includes a battery charger circuit 602 (including a battery), a coil driver 604, and a female socket connector 606 configured to receive the first connector 404 of the cable 400, that includes the multi-wire bundle 408 disposed within a cable jacket (not shown). High pass filters 610 and low pass filters 612 are also utilized in the BTE portion 600. The external portion 620 includes a connector 622 and a coil 624. The high frequency sinusoid is generated by the coil drivers and is typically present on the two wires of the wire bundle 408 is delivered to the coil 624 of the external portion 620 via the connector 622. In certain embodiments, this frequency may be about 5 MHz. When the wires of the wire bundle 408 are used for the transmission of power from power connector 402, the DC power (at 0 MHz) is separated from the 5 MHz data signal sent to the coil 624. The high pass filters 410, 610 and low pass filters 412, 612 separate the power signal from the data signal. The high pass filters 410, 610 prevent transmission of DC power to the coil 624 and the coil driver 604. The low pass filters 412, 612 prevent transmission of data to the battery charger 602 or back to the power connector 402.

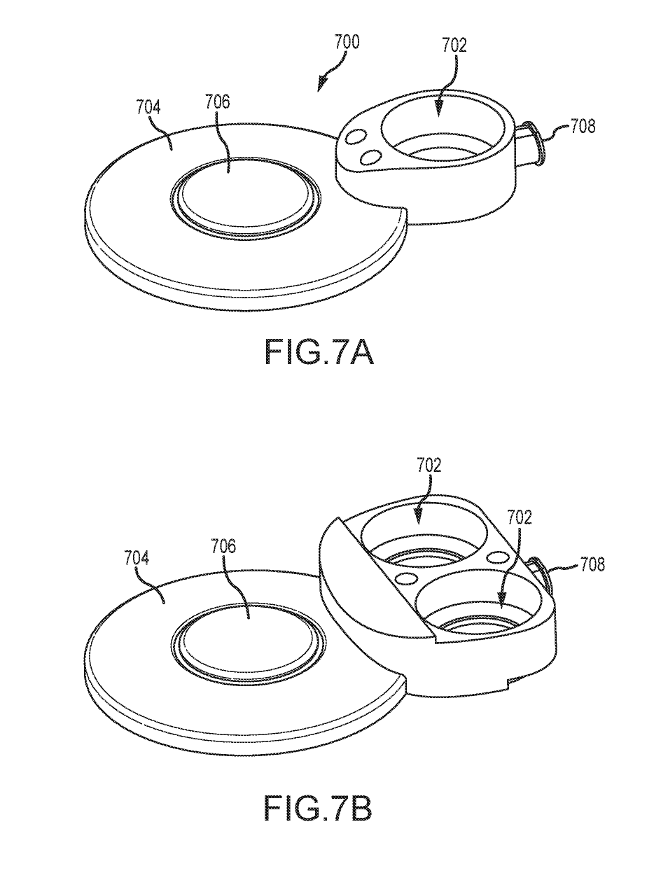

In general, the embodiments depicted herein contemplate auditory prostheses having at least one rechargeable battery disposed within the BTE portion thereof. Power from a discrete power source is delivered to both the BTE portion (to charge the battery) and to the external portion (to enable hearing functionality of the auditory prosthesis) during charging. FIGS. 7A-7B are partial perspective views of external portions 700 of auditory prostheses, wherein the external portions 700 have their own discrete batteries, which can be rechargeable in certain embodiments. In FIG. 7A, a battery compartment 702 receives a battery (not shown) and is disposed proximate a signal transmission coil 704. FIG. 7B depicts two battery compartments 702, thus requiring two batteries. A magnet 708, such as described elsewhere herein, is disposed within the coil 704. The battery compartment 702 can be closed with a cover (not shown). A connector 708 (in this case a female socket or plug connector) is configured to receive a connector from a power and data signal transmission cable, such as those depicted and described herein. In these embodiments of external portions 700, charging power can be delivered from a discrete power source so as to charge the battery disposed in the external portion 700, while still powering the external portion 700 so as to enable hearing. In other embodiments, the batteries disposed in the external portion 700 can be used to charge the battery disposed in an associated BTE portion while still powering the external portion 700.

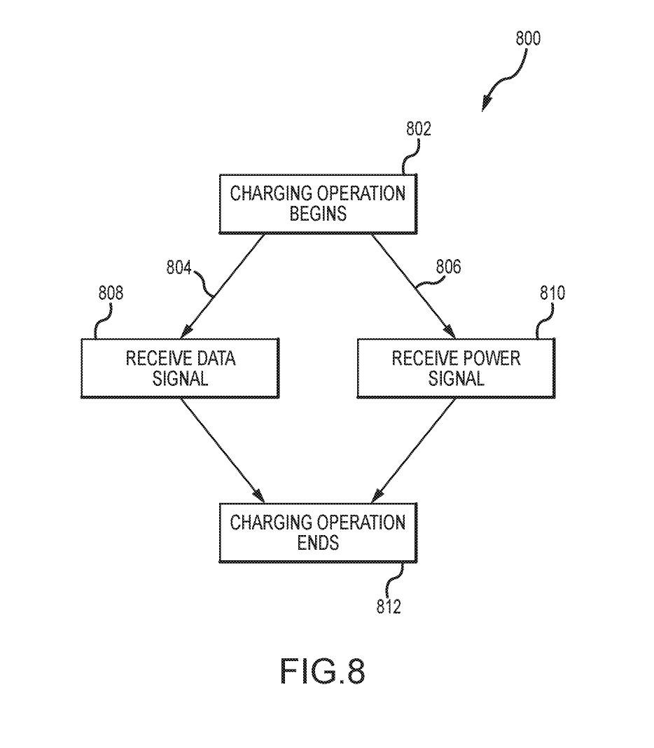

FIG. 8 is a method 800 of charging and transmitting data between components of an auditory prosthesis. The method 800 begins at operation 802, where the charging operation begins. This can occur when a power and data signal transmission cable, such as the types described herein, are connected between various components of an auditory prosthesis and a need for charging of a battery is detected. Thereafter, a data signal is received at an external portion of the auditory prosthesis at operation 808, typically from a BTE portion. A power signal is also received at the external portion at operation 810, typically from a discrete power source. If the power and data wires in the cable are discrete from each other, these power and data signals are received by the external portion substantially simultaneously, as depicted by parallel paths 804, 806. This receipt of power and data signals continues until charging ends at operation 812. In embodiments where power and data are sent alternatively over a single wire (such as in the embodiment depicted in FIGS. 4 and 6), the power and data signals are frequency multiplexed. Indeed, over the entire method 800, this frequency multiplexing can also be considered substantially simultaneous.

This disclosure described some embodiments of the present technology with reference to the accompanying drawings, in which only some of the possible embodiments were shown. Other aspects can, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the technology is not limited to those specific embodiments. One skilled in the art will recognize other embodiments or improvements that are within the scope of the present technology. Therefore, the specific structure, acts, or media are disclosed only as illustrative embodiments. The scope of the technology is defined by the following claims and any equivalents therein.

What is claimed is:

1. An apparatus comprising:
a first wearable component;
a second wearable component adapted to be worn discrete from the first wearable component; and
a cable comprising:
a power connector adapted to be connected to a discrete power source;
a first connector adapted to be connected to the first wearable component;
a second connector adapted to be connected to the second wearable component; and
a wire operatively connected to the first connector, the second connector, and the power source connector.

2. The apparatus of claim 1, wherein the first wearable component comprises a sound processor and the second wearable component comprises a transmission element.

3. The apparatus of claim 2, wherein the transmission element comprises at least one of an induction coil and a vibration element.

4. The apparatus of claim 1, wherein the discrete power source comprises at least one of a battery, a building power supply, and an energy scavenging unit.

5. The apparatus of claim 1, wherein the wire comprises a wire bundle comprising a power wire and a data wire.

6. The apparatus of claim 5, wherein when the cable is connected to each of a power source, the first wearable component, and the second wearable component, a data signal is sent on the data wire substantially simultaneously with a power signal being sent on the power wire.

7. The apparatus of claim 1, further comprising a voltage transformer disposed on the power wire, wherein the voltage transformer alters a voltage of the power signal sent to at least one of the first connector and the second connector.

8. The apparatus of claim 1, wherein the wire comprises a wire bundle comprising:
a first power wire connecting the power connector to the first connector; and
a second power wire connecting the power connector to the second connector.

9. The apparatus of claim 2, wherein the first wearable component comprises a battery and a charging circuit connected to the battery, and wherein the wire is connected to the charging circuit.

10. An apparatus comprising:
a cable jacket;
a power connector secured to the cable jacket;
a first connector secured to the cable jacket and adapted to be connected to a first wearable component;
a second connector secured to the cable jacket and adapted to be connected to a second wearable component; and
a wire disposed in the cable jacket, wherein the wire connects the first connector and the second connector.

11. The apparatus of claim 10, wherein the wire connects the power connector to both of the first connector and the second connector.

12. The apparatus of claim 11, further comprising a voltage transformer disposed on the wire between the power source connector and at least one of the first connector and the second connector.

13. The apparatus of claim 10, wherein the wire comprises a wire bundle comprising:
a first power wire connected to the power connector and the first connector, and
a second power wire connected to the power connector and the second connector.

14. The apparatus of claim 13, wherein the wire bundle further comprises a data wire connected to the first connector and the second connector.

15. The apparatus of claim 10, further comprising at least one of:
a vehicle power adapter;
a battery housing; and
a power plug, wherein the at least one of the vehicle power adapter, the battery housing, and the power plug are adapted to be connected to the power connector.

16. The apparatus of claim 10, wherein the first connector comprises a male connector and the second connector comprises a female connector.

17. The apparatus of claim 16, wherein the male connector and the female connector are disposed within an integral housing.

18. The apparatus of claim 10, wherein both of the first connector and the second connector comprise a male connector.

19. A method comprising:
receiving, at a first component of an auditory prosthesis, a data signal sent from a second component of the auditory prosthesis; and
substantially simultaneously receiving, at the first component, a power signal sent from a power source discrete from both the first component and the second component.

20. The method of claim 18, wherein substantially simultaneously receiving comprises automatically alternatingly receiving the data signal and the power signal.
